(19) United States
(12) Patent Application Publication
(10) Pub. No.: US 2009/0301574 A1
(43) Pub. Date: Dec. 10, 2009

(54) MECHANISM FOR CONTROLLING A GAUGE FOR INDICATING THE AMOUNT OF GAS REMAINING IN A GAS TANK

(76) Inventor: WILLIAM HOME, Taipei (TW)

Correspondence Address: LEONG C LEI, PMB # 1008, 1867 YGNACIO VALLEY ROAD, WALNUT CREEK, CA, 94598, US

(21) Appl. No.: 12/135,223

(22) Filed: Jun. 9, 2008

(51) Int. Cl. F16K 31/24; F16K 33/00

(52) U.S. Cl. 137/444; 141/95; 141/198; 137/446

(57) ABSTRACT

An overfill prevention device which includes a first tubular member, a cylindrical piston fitted within the first tubular member, a second tubular member having a cylindrical recess open, a plug arranged within the second tubular member, a float rod having a cam plate, a float connected with a lower end of the float rod, a valve body having a lower end engaged with the first tubular member, a pinion pivotally connected to the second tubular member by the pin, a toothed rack meshed with the pinion and engaged with the second tubular member, a control rod having an upper end extending into the valve body and a lower end secured to the toothed rack, a first magnet mounted at the upper end of the control rod, and a gauge mounted on the valve body and provided with a second permanent magnet and a needle operatively connected with the second magnet.

### CROSS-REFERENCE

This application is related to U.S. Pat. No. 6,138,709, owned by the same applicant.

### BACKGROUND OF THE INVENTION

(a) Technical Field of the Invention

This invention is related to a mechanism which is arranged in an overfill prevention device and used for controlling a gauge for indicating the amount of gas remaining in a gas tank.

(b) Description of the Prior Art

Combustible liquefied gas is convenient for us to carry out combustion operation, and especially as liquefied gas burns completely. The burning is very clean, and unlike coal, no black smoke will be produced. Hence, liquefied gas is widely used for heating, and cooking. Further, liquefied gas is also used for welding and manufacturing. However, no matter what kind of liquefied gas is used, they must all be filled in a gas tank in order to facilitate their transportation. When in use, the outlet of the gas tank is connected to the burner, so that when the gas tank is turned open, the liquefied gas tank will flow to the burner for burning.

Generally, the conventional gas tank is provided with a simple valve. When the liquefied gas is decreased to a level such that it is insufficient for cooking a meal, the user cannot perceive this, so that it often happens that cooking will be interrupted as a result. Thus, the user has to purchase a new gas tank or refilling gas in order to continue cooking, which is inconvenient, particularly for people located far from gas stations or the like. However, it is also dangerous to have multiple gas tanks in the home.

Therefore, it is an object of the present invention to provide an overfill prevention device with a gauge for indicating the amount of gas remaining in a gas tank which can obviate and mitigate the above-mentioned drawbacks.

### SUMMARY OF THE INVENTION

This invention is related to a mechanism which is arranged in an overfill prevention device and used for controlling a gauge for indicating the amount of gas remaining in a gas tank.

According to a preferred embodiment of the present invention, there is provided an overfill prevention device which includes a first tubular member, a cylindrical piston fitted within the first tubular member, a second tubular member having a cylindrical recess open, a plug arranged within the second tubular member, a float rod having a cam plate, a float connected with a lower end of the float rod, a valve body having a lower end engaged with the first tubular member, a pinion pivotally connected to the second tubular member by the pin, a toothed rack meshed with the pinion and engaged with the second tubular member, a control rod having an upper end extending into the valve body and a lower end secured to the toothed rack, a first magnet mounted at the upper end of the control rod, and a gauge mounted on the valve body and provided with a second permanent magnet and a needle operatively connected with the second magnet.

It is the primary object of the present invention to provide a mechanism which utilizes a float movement to rotate a pinion which in turn drives a toothed rack to accurately indicate the amount of gas remaining in a gas tank.

It is still another object of the present invention to provide an overfill prevention device with a gauge for indicating the amount of gas remaining in a gas tank which has a very short purging time.

It is still another object of the present invention to provide an overfill prevention device with a gauge for indicating the amount of gas remaining in a gas tank which is simple in construction.

It is a further object of the present invention to provide an overfill prevention device with a gauge for indicating the amount of gas remaining in a gas tank which is cheap and easy to manufacture.

The foregoing objects and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of the present invention;

FIG. 2 is an exploded view of the present invention;

FIG. 3 is a longitudinal sectional view of the present invention;

FIG. 3A is a front view of the gauge according to the present invention;

FIG. 3B is a side view of the gauge according to the present invention;

FIG. 4 is another longitudinal sectional view of the present invention;

FIGS. 5, 6, 6A and 7 are sectional views illustrating the working principle of the present invention;

FIG. 7A is a front view of the gauge indicating the amount of gas remaining in the gas tank;

FIG. 8 is a longitudinal sectional view of the present invention in the filling position;

FIG. 9 is a longitudinal sectional view of the present invention in the stop-fill position; and

FIG. 10 is a longitudinal sectional view of the present invention in the purging position.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

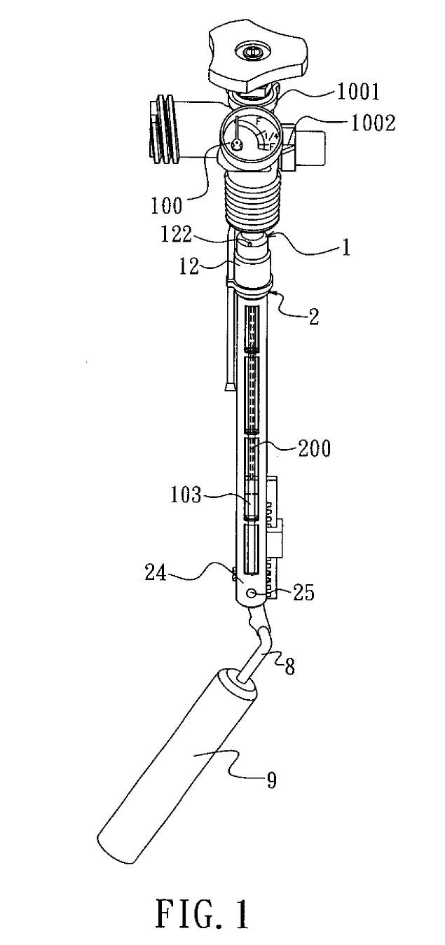

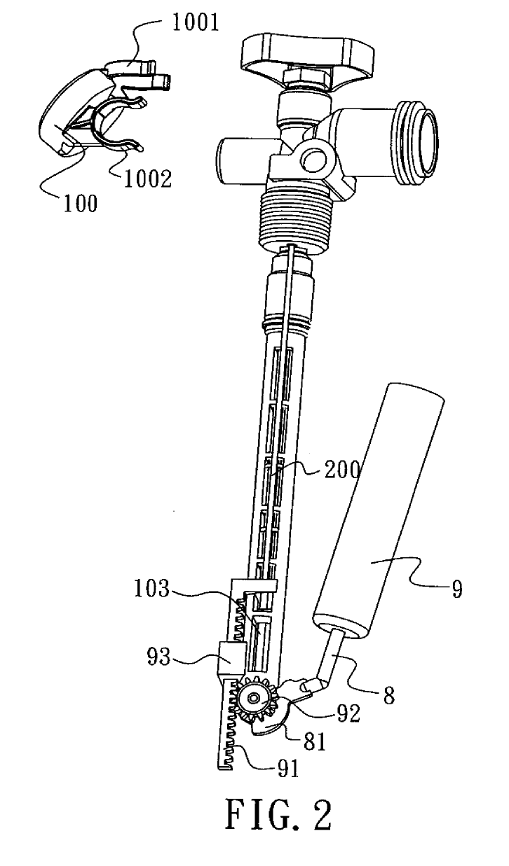

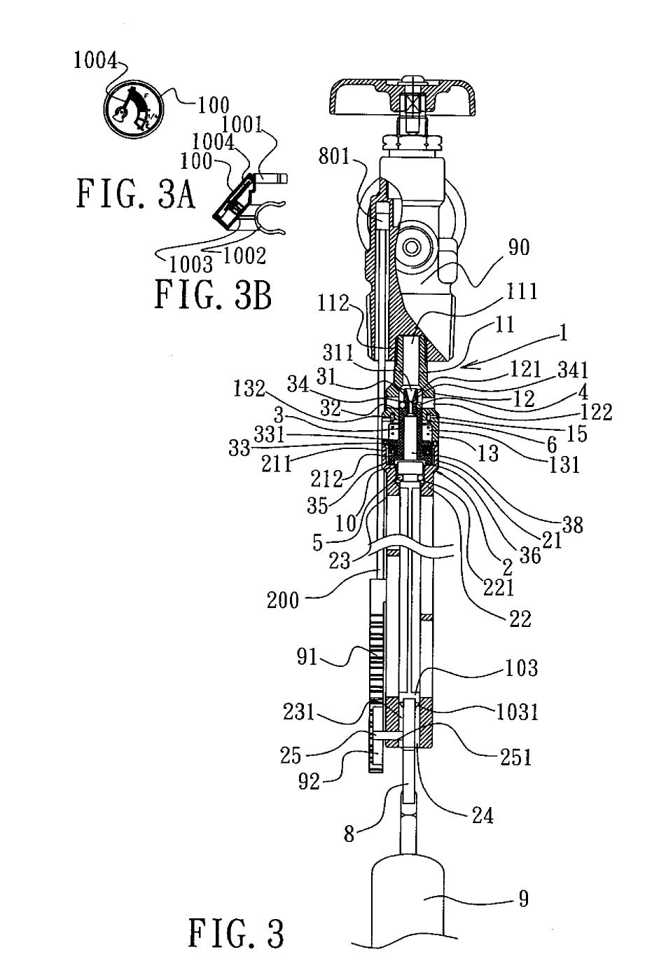

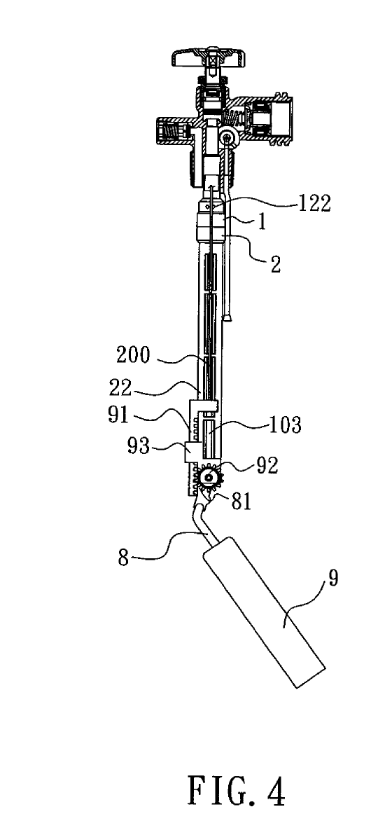

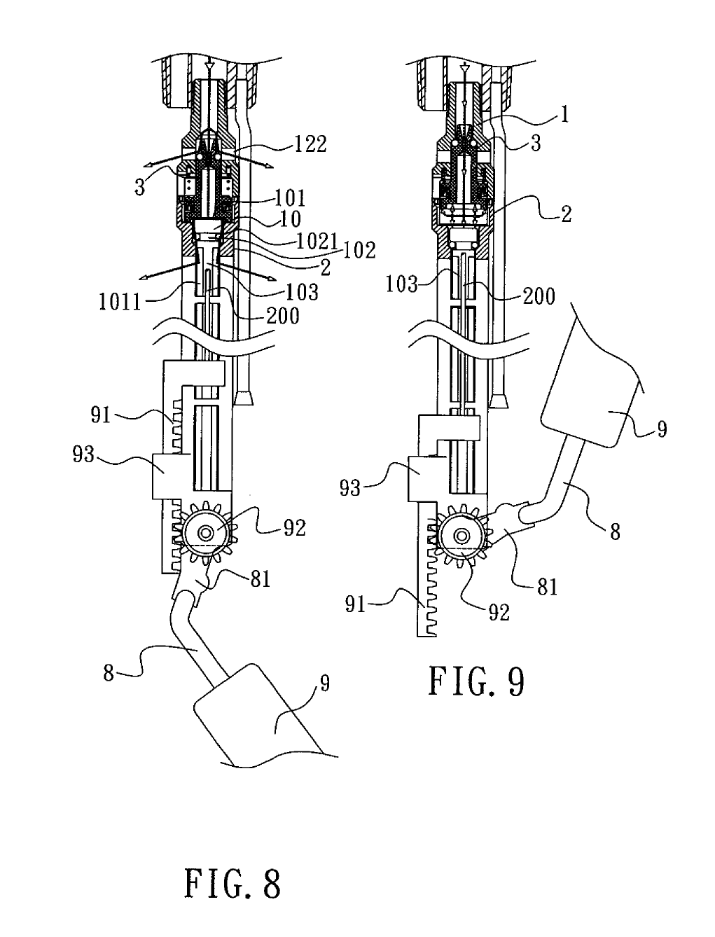

Referring to FIGS. 1, 2, 3, 3A, 3B, 4, 8, 9 and 10, the overfill prevention device with the mechanism for controlling a gauge for indicating the amount of gas remaining in a gas tank according to the present invention generally comprises a first tubular member 1 (see FIGS. 1 and 4), a second tubular member 2 (see FIGS. 1 and 4), a piston 3 (see FIGS. 3, 8 and 9), a first O-ring 4 (see FIG. 3), a second O-ring 5 (see FIG. 3), a compressed spring 6 (see FIG. 3), a pinion 92 (see FIGS. 2, 3, 4, 8, 9 and 10), a toothed rack 91 (see FIGS. 2, 3, 4, 8, 9 and 10), a float rod 8 (see FIGS. 1, 2 and 3), a float 9 (see FIGS. 1, 2 and 3), a plug 10 (see FIGS. 3 and 8), a control rod 200 (see FIGS. 1, 2, 3), a pressure valve having a valve body 90 (see FIG. 9), and a gauge 100 (see FIGS. 3A and 3B).

The first tubular member 1 has an upper portion 11 formed with a first axial through hole 111 and external threads 112, an intermediate portion 12 having a second axial through hole 121 with a larger diameter than the first axial through hole 111 of the upper portion 11 and two radial through holes 122, and a lower portion 13 having a third axial through hole 131 with a larger diameter than the second axial through hole 121 of the intermediate portion 12. An annular groove 132 is formed between the second and third axial through holes 121 and 131. The first tubular member 1 is formed with a radial perforation 15 which extends therethrough to communicate with the annular groove 132 so that the pressure required for the operation of the piston 3 can be reduced thus making the overfill prevention device become more sensitive. According to the experiment, the preferred diameter of the radial perforation 15 is around 1 mm+0.5 mm. The two radial through holes 122 are aligned with each other.

The piston 3 is a cylindrical member with an upper portion 31 dimensioned to fit into the first axial through hole 111 of the first tubular member 1, an intermediate portion 32 having a larger diameter than the upper portion 31 and dimensioned to fit into the second axial through 121 of the first tubular member 1, a lower portion 33 having a larger diameter than the intermediate portion 32 and dimensioned to fit into the third axial through hole 131 of the first tubular member 1, a first neck portion 34 between the upper and intermediate portions 31 and 32, a second neck portion 35 on lower portion 33, and a circular recess 36 at the bottom of the lower portion 33. The upper portion 31 of the piston 3 is formed with a conical through hole 311 having an upper diameter and a lower diameter which are in the ratio of three to one. The first neck portion 34 has an axial through hole 341 having the same diameter as the lower end of the conical through hole 311. An axial through hole 38 is formed in the intermediate and lower portions 32 and 33 and has an upper and lower ends communicated with the axial through hole 341 and the circular recess 36 respectively. The piston 3 is slidably disposed within the first tubular member 1.

The compressed spring 6 is arranged within the third axial through hole 131 of the lower portion 13 of the first tubular member 1 and fitted over the intermediate portion 32 of the piston 3, with its upper and lower ends respectively bearing against the annular groove 132 of the first tubular member 1 and the flange 331 of the lower portion 33 of the piston 3.

The first and second O-rings 4 and 5 are fitted in the first and second neck portions 34 and 35 of the piston 3, respectively.

The second tubular member 2 has an upper portion 21 having a cylindrical recess 211 open at the top and joined with the lower end of the first tubular member 1 by ultrasonic welding, an intermediate portion 22 having an axial through hole 221 with a smaller diameter than the third axial through hole 131 of the first tubular member 1, and a lower portion 23 having an axial through hole 231 with a smaller diameter than the axial through hole 221 of the intermediate portion 22. The lower end of the second tubular member 2 is divided by a diametrical slot 24 into two similar semi-cylindrical portions and has a radial circular hole 251 extending through the two semi-cylindrical portions. The pinion 92 is pivotally mounted at the lower end of the second tubular member 2 by a pin 25 extending through the radial circular hole 251. The second tubular member 2 is formed with a protruded block 93 through which is slidably fitted the toothed rack 91. The toothed rack 91 is threadedly engaged with the pinion 92. The control rod 200 has an upper end extending upwardly into the valve body 90 to connect with a magnet 801. The lower end of the control rod 200 is secured to the toothed rack 91, so that when the float 9 is moved, the pinion 92 will be rotated thereby moving the toothed rack 91 and the control rod 200 in unison with the float 9 and therefore moving the magnet 801 up or down in the valve body 90.

Referring to FIGS. 3 and 8, the plug 10 is a cylindrical member having an upper portion 101 formed with a plurality of longitudinal grooves 1011, a neck portion 102 under the upper portion 101 and fitted with an O-ring 1021, and a lower portion 103 having a smaller diameter than the axial through hole 231 of the second tubular member 2 and formed with a conical lower end 1031. The plug 10 is arranged within the second tubular member 2 and located under the piston 3.

The float rod 8 is an elongated member having a cam plate 81 at the upper end. The float rod 8 is integrally formed with the cam plate 81. The cam plate 81 of the float rod 8 is fitted into the slot 24 of the second tubular member 2 and pivotally connected thereto by the pin 251 extending through the radial circular hole 25 of the second tubular member 2 and the circular hole 72 of the float rod 8 so that the float rod 8 can be rotated with respect to the second tubular member 2. The cam plate 81 is contoured to form a lobe, a convex edge and a concave edge. The lower end of the float rod 8 is fixedly secured to the interior of the float 9.

The upper portion of the first tubular member 1 is engaged with the lower end of the valve body 90. The gauge 100 is provided with two clamps 1001 and 1002 for fixing on the valve body 90. The interior of the gauges 100 is provided with a permanent magnet 1003 and a needle 1004 which is operatively connected with the permanent magnet 1003. The structure of the gauge 100 may be of any conventional design well known to those skilled in the art. The gauge 100 is mounted on the valve body 90 so that the permanent magnet 1003 of the gauge is positioned against the permanent magnet 801 of the control rod 80.

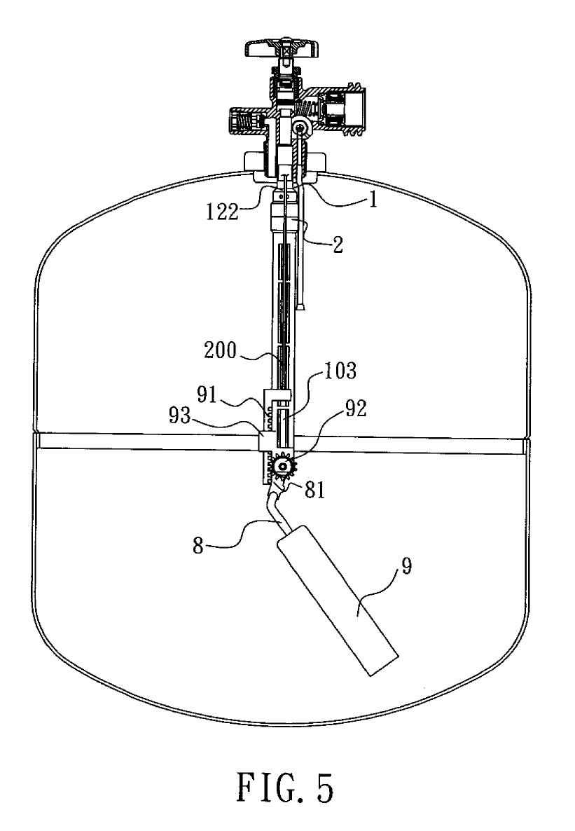

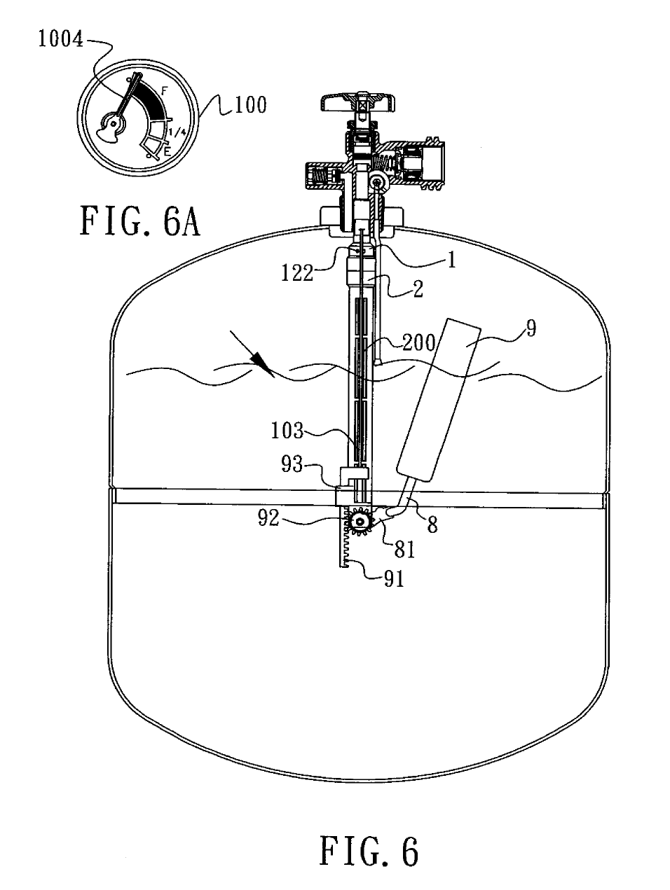

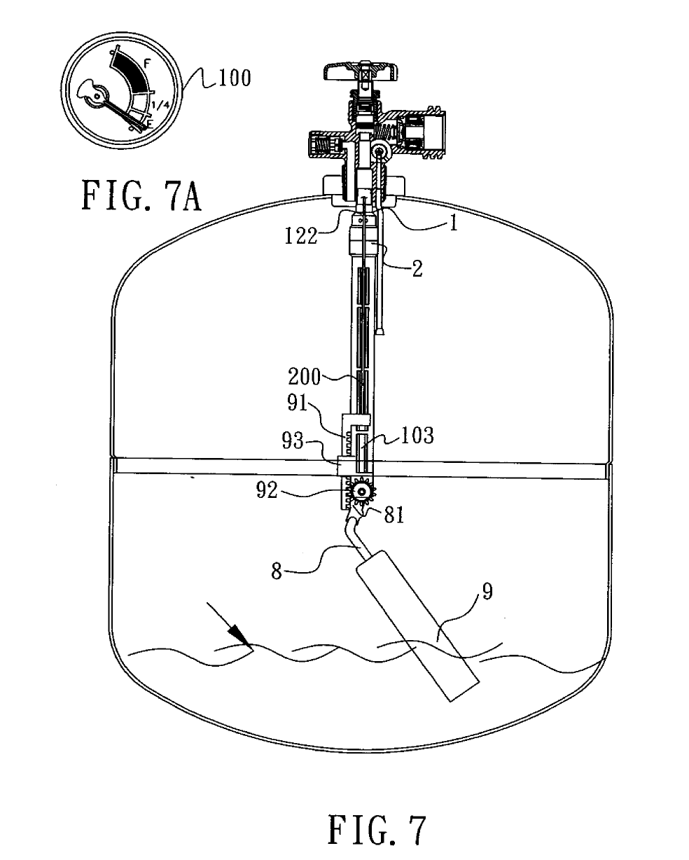

When in use (see FIGS. 5, 6 and 7), the upper end of the first tubular member 1 of the overfill prevention device according to the present invention is connected to a pressure valve. The pressure valve may be of any conventional design well known to those skilled in the art and is not considered a part of the invention. As the pressure valve is turned open, gas will flow through the pressure valve and the overfill prevention device into a tank. The float 9 will be positioned as shown in FIG. 8 when pressurized gas is being filled into the tank. When pressurized gas is being filled into the tank, the float 9 will be moved upward thereby causing the cam plate 81 to rotate. As the cam plate 81 is rotated from the convex edge to the concave edge, the plug 10 will go downward. The cam plate 81 will continue to rotate when pressurized gas keeps filling into the gas tank. As the pressure within the tank reaches the predetermined level, the float 9 will be rotated upwardly with respect to the second tubular member 2 thereby moving the concave edge of the cam plate 81 of the float rod 8 to the position right under the conical lower end 1031 of the plug 10. In the meantime, the upper end of the plug 10 is positioned to seal the axial through hole 221 of the second tubular member 2. As the gas cannot flow through the second tubular member 2, it will be forced to go upwardly thereby lifting the piston 3 until the first O-ring 4 bears against the first axial through hole 111 of the first tubular member 1 and the radial through holes 122 are closed by the intermediate portion 32 of the piston 3. Hence, no more gas is allowed to flow through the overfill protection device according to the present invention when the pressure within the tank exceeds the predetermined level. As the control rod 200 will be moved in unison with the float 9, the magnet 801 mounted at the upper end of the control rod 200 will be moved up or down in the valve body 90 thereby forcing the magnet 1003 of the gauge 100 to move and therefore moving the needle 1004 to indicate the amount of gas remaining in the gas tank (see FIGS. 6A and 7A).

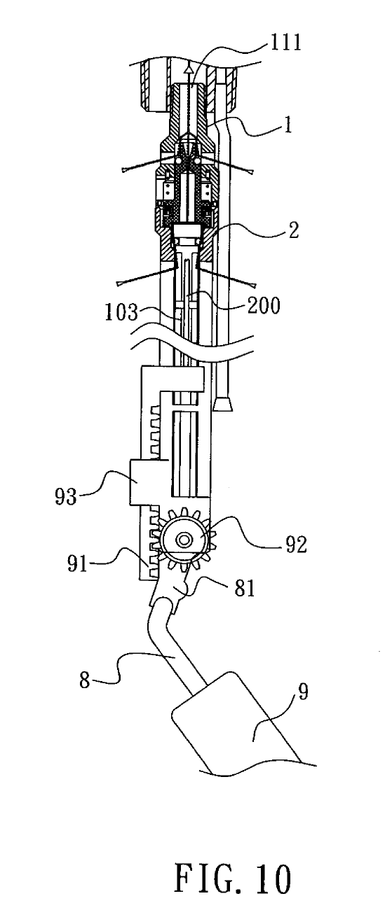

FIG. 10 is a longitudinal sectional view of the overfill prevention device in the purging position. As shown, most of the gas will directly flow out of the overfill prevention device through the radial through holes 111 of the first tubular member 1. In other words, the flow rate of the gas in purging will not be limited by the small passage of the piston thus largely decreasing the time required for gas purging.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. In an overfill prevention device comprising a first tubular member, a cylindrical piston slidably fitted within the first tubular member, a spring arranged within the first tubular member, a first and second O-rings fitted in the first and second neck portions of the piston, a second tubular member having a cylindrical recess open at a top, a plug arranged within the second tubular member, a float rod having a cam plate at an upper end, a float connected with a lower end of the float rod, a valve body having a lower end engaged with the first tubular member, the improvement wherein a pinion is pivotally connected to said second tubular member by said pin, a toothed rack meshed with said pinion and slidably fitted in a protruded block of said second tubular member, a control rod having an upper end and a lower end, said upper end of said control rod extending upwardly into said valve body, said lower end being secured to said toothed rack, a first magnet mounted at said upper end of said control rod, and a gauge mounted on said valve body and provided with a second permanent magnet and a needle operatively connected with said second magnet, whereby when said float is moved, said pinion will be rotated thereby moving said toothed rack and said control rod in unison with said float, so that said first magnet mounted at said upper end of said control rod will be moved up or down in said valve body thereby forcing said second magnet to move and therefore moving said needle to indicate amount of gas remaining in a gas tank.

2. The overfill prevention device as claimed in claim 1, wherein said lower of said control rod is secured to a top end of said toothed rack.

3. The overfill prevention device as claimed in claim 1, wherein said conical through hole of said piston has an upper diameter and a lower diameter which are in a ratio of three to one.

4. The over fill prevention device as claimed in claim 1, wherein said first tubular member is formed with a radial perforation extending through said first tubular member to communicate with said annular groove.
